(19) United States
(12) Patent Application Publication
(10) Pub. No.: US 2020/0260277 A1
(43) Pub. Date: Aug. 13, 2020

(54) METHOD FOR WIRELESS ACCESS AUTHENTICATION

(71) Applicant: SHANGHAI LIANSHANG NETWORK TECHNOLOGY CO., LTD., SHANGHAI (CN)

(72) Inventor: HAN CHENG, SHANGHAI (CN)

(21) Appl. No.: 16/862,587

(22) Filed: Apr. 30, 2020

Related U.S. Application Data
(63) Continuation of application No. PCT/CN2018/109893, filed on Oct. 11, 2018.

(30) Foreign Application Priority Data
Oct. 31, 2017 (CN) 201711043197.7

(51) Int. Cl. H04W 12/06; H04W 12/00; H04W 12/08; H04W 76/11

(52) U.S. Cl. CPC H04W 12/06; H04W 76/11; H04W 12/08; H04W 12/0051

(57) ABSTRACT

The present application provides a method for wireless access authentication without connection. The method comprises: rejecting, by a wireless routing device, a connection request sent by a terminal device and recording a connection event until a preset condition is satisfied; parsing from recorded connection events of the terminal device to derive authentication information of the terminal device; authenticating the terminal device by using the authentication information. According to the method of the present application, a terminal device can send authentication information to a wireless routing device without connection and access the wireless routing device after authentication is passed by simply obtaining the authentication information allocated by a network device for the terminal device in advance. The flexibility of use of wireless access is improved.

### CROSS REFERENCE TO THE RELATED APPLICATION

This application is the continuation application of International Application No. PCT/CN2018/109893, filed on Oct. 11, 2018, which is based upon and claims priority to Chinese Patent Application No. 201711043197.7, filed on Oct. 31, 2017, the entire contents of which are incorporated herein by reference.

### FIELD

The present application relates to internet applications, more particularly relates to a method for wireless access authentication.

### BACKGROUND

In the prior art, a traditional Wireless Fidelity (WiFi) connection authentication method requires that a terminal device first establish a network connection with a network device through a public network or a local wireless access network. The network device stores information on a large number of wireless routing devices and their corresponding access information. The terminal device obtains the access information of the wireless access routing device returned by the network device, and establishes a network connection with the wireless routing device by inputting the access information to the wireless routing device.

However, the prerequisite for the above-mentioned method is that the terminal device has to first establish a network connection with the network device in order to obtain access information of the wireless routing device from the network device, and access the wireless network device according to the access information. However, in many application scenarios, the terminal device cannot establish a network connection, for example, no network, which means that the terminal device cannot obtain the access information of the wireless routing device from the network device, that is, the terminal device cannot establish a wireless connection with the wireless routing device.

### SUMMARY

Various embodiments of the present application provide a method for wireless access authentication used for wireless access authentication without connection.

In an embodiment of the present application, it is provided a method for wireless access authentication. The method comprises:

rejecting, by a wireless routing device, a connection request sent by a terminal device and recording a connection event until a preset condition is satisfied;

parsing from recorded connection events of the terminal device to derive authentication information of the terminal device;

authenticating the terminal device by using the authentication information.

According to the above-mentioned embodiment and any possible implementation, an implementation is further provided, and the connection request is sent for a first device identifier of the wireless routing device.

According to the above-mentioned embodiment and any possible implementation, an implementation is further provided, and the method further comprises:

if a connection request for a second device identifier of the wireless routing device sent by a terminal device that has passed authentication is received, permitting the terminal device that has passed authentication to access the second device identifier.

According to the above-mentioned embodiment and any possible implementation, an implementation is further provided, and rejecting, by the wireless routing device, the connection request sent by the terminal device and recording a connection event until a preset condition is satisfied comprises:

determining, by the wireless routing device, whether the terminal device sending the connection request has passed authentication; if no, rejecting the connection request sent by the terminal device and recording a connection event until a preset condition is satisfied.

According to the above-mentioned embodiment and any possible implementation, an implementation is further provided, and the preset condition comprises: a connection request sent by the terminal device is not received when a preset time period is passed, or the connection request sent by the terminal device has been rejected for a preset number of times.

According to the above-mentioned embodiment and any possible implementation, an implementation is further provided, and an SSID in the first device identifier is a hidden SSID and an SSID in the second device identifier is an open SSID; or an SSID in the first device identifier is an open SSID and an SSID in the second device identifier is an open SSID.

According to the above-mentioned embodiment and any possible implementation, an implementation is further provided, and parsing from recorded connection events of the terminal device to derive the authentication information comprises: parsing connection events of the terminal device into a code string according to a preset rule.

According to the above-mentioned embodiment and any possible implementation, an implementation is further provided, and the preset rule comprises: receiving a connection request is represented by a binary code 1 and waiting for a preset time interval is represented by a binary code 0.

According to the above-mentioned embodiment and any possible implementation, an implementation is further provided, and authenticating the terminal device by using the authentication information comprises:

determining whether the parsed code string matches with a preset code string; and if yes, authentication is passed, otherwise authentication fails.

According to the above-mentioned embodiment and any possible implementation, an implementation is further provided, and the preset code string comprises:

a preset code string obtained from a network device by the wireless routing device or a built-in code string of the wireless routing device.

According to the above-mentioned embodiment and any possible implementation, an implementation is further provided, and the method further comprises: returning the authentication result to the terminal device.

In another embodiment of the present application, it is provided a method for wireless access authentication. The method comprises:
sending a connection request to a wireless routing device for multiple times according to a preset rule, so that the wireless routing device rejects the connection request, records a connection event until a preset condition is satisfied, and authenticating the terminal device by using authentication information of the terminal device parsed from the connection events;

sending a connection request to the wireless routing device one more time.

According to the above-mentioned embodiment and any possible implementation, an implementation is further provided, and sending a connection request to the wireless routing device for multiple times according to a preset rule comprises:

sending a connection request for a first device identifier of the wireless routing device for multiple times according to the preset rule.

According to the above-mentioned embodiment and any possible implementation, an implementation is further provided, and sending a connection request to the wireless routing device one more time comprises:

sending a connection request for a second device identifier of the wireless routing device.

According to the above-mentioned embodiment and any possible implementation, an implementation is further provided, and an SSID in the first device identifier is a hidden SSID and an SSID in the second device identifier is an open SSID; or an SSID in the first device identifier is an open SSID and an SSID in the second device identifier is an open SSID.

According to the above-mentioned embodiment and any possible implementation, an implementation is further provided, and sending a connection request to the wireless routing device one more time comprises:

sending a connection request to the wireless routing device one more time when a preset time period is passed after completing sending of a connection request to the wireless routing device for multiple times; or sending a connection request to the wireless routing device one more time after information indicating that authentication is passed is returned by the wireless routing device is obtained.

According to the above-mentioned embodiment and any possible implementation, an implementation is further provided, and the preset rule comprises: sending a connection request to the wireless routing device for multiple times according to a connection request sending mechanism indicated by a preset code string, 1 in the code string indicates sending a connection request and 0 indicates waiting for a preset time interval.

According to the above-mentioned embodiment and any possible implementation, an implementation is further provided, and the preset code string comprises: a preset code string set for the terminal device by a network device, or a built-in code string of the wireless routing device sent by the network device to the terminal device.

In a further embodiment of the present application, it is provided a device. The device comprises:

one or more processors;

a storage device for storing one or more programs, the one or more programs, when executed by the one or more processors, cause the one or more processors to implement any of the above-mentioned methods.

In a yet further embodiment of the present application, it is provided a computer readable storage medium storing computer programs thereon, the programs, when executed by a processor, implement any of the above-mentioned methods.

According to the embodiments of the present application, a terminal device can implement wireless access authentication even without network connection to access a wireless routing device. The flexibility of use of wireless access is improved.

### DESCRIPTIONS OF THE DRAWINGS

Embodiments of the present application, the following will briefly introduce the drawings required in the description of the embodiments or the prior art. Hence, the drawings in the following description are some embodiments of the present application. In some embodiments, other drawings can also be obtained from these drawings.

FIG. 1 is a schematic flowchart of a method for wireless access authentication provided by a first embodiment of the present application;

FIG. 2 is a schematic flowchart of a method for wireless access authentication provided by a second embodiment of the present application;

FIG. 3 is a schematic flowchart of a method for wireless access authentication provided by a third embodiment of the present application;

FIG. 4 is a schematic flowchart of a method for wireless access authentication provided by a fourth embodiment of the present application;

FIG. 5 is a block diagram of an exemplary computer system/server suitable for implementing the embodiments of the present disclosure.

### DETAILED EMBODIMENTS

The embodiments of the present application will be described clearly and completely below in conjunction with the drawings in the embodiments of the present application. Hence, the described embodiments are a part of embodiments of the present application, not all the embodiments.

In addition, the term “and/or” in this document is merely an association relationship describing the associated objects, indicating that there can be three types of relationships. For example, A and/or B can represent the following three types of situations: A exists alone, A and B exist at the same time, B exists alone. In addition, the character “/” in this document generally represents that the associated objects before and after the character are in an “or” relationship.

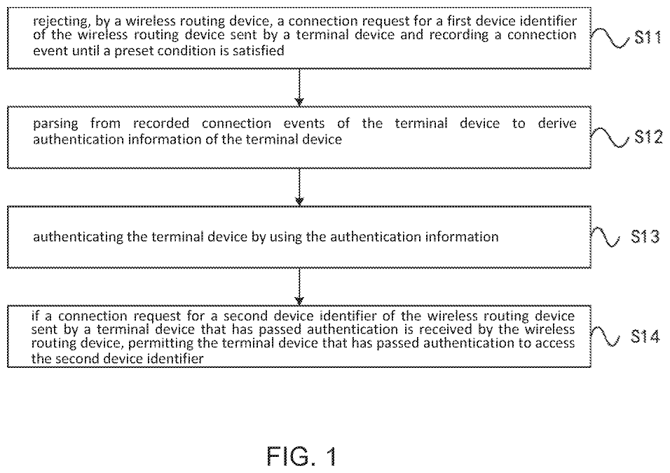

FIG. 1 is a schematic flowchart of a method for wireless access authentication provided by a first embodiment of the present application. As illustrated in FIG. 1, the method comprises the following steps:

step S11, rejecting, by a wireless routing device, a connection request sent by a terminal device for a first device identifier of the wireless routing device, and recording a connection event until a preset condition is satisfied;
step S12, parsing from recorded connection events of the terminal device to derive authentication information of the terminal device;

step S13, authenticating the terminal device by using the authentication information;

step S14, if a connection request for a second device identifier of the wireless routing device sent by a terminal device that has passed authentication is received by the wireless routing device, permitting the terminal device that has passed authentication to access the second device identifier.

The method of FIG. 1 may be performed by the wireless routing device.

The wireless routing device may be an access point providing wireless network access service, a terminal device hotspot, etc. The wireless network includes, but is not limited to, a wireless local area network based on the IEEE802.11 series of standard protocols, for example, a wireless local area network based on the IEEE802.11n protocol, that is, a commonly-called WiFi network. The terminal device may access a corresponding wireless network through the wireless routing device. In subsequent embodiments of the present disclosure, a wireless routing device accessing a WiFi network will be used as an example for description.

The terminal device includes but is not limited to any type of smart terminal device for implementing wireless communication functions, such as a smart phone, a tablet computer, etc. The smart terminal device can adopt any operating system, such as an Android operating system, an iOS operating system, a Windows operating system, etc.

In one implementation of step S11, the wireless routing device is configured with a plurality of device identifiers. The device identifier is an SSID (service set identifier) of a wireless access point. The SSID is used to identify a wireless network corresponding to the wireless routing device. Further, the SSID may be further refined into BSSID (Basic Service Set Identifier) and ESSID (Extended Service Set Identifier, Service Differentiation Number), the BSSID is used to identify a relatively small BSS (Basic Service Set, base station system) area, each host communicates in this relatively small area, while the ESSID is applied to a more complex wireless network with a larger scale.

Here, different BSSs can be extended to corresponding ESSs (Extended Service Set, multiple base station systems). In subsequent embodiments of the present disclosure, the MAC (Media Access Control) of a wireless access point is used as the BSSID of the wireless access point. In one embodiment, the device identifier is the SSID and BSSID of the wireless access point.

In one embodiment, the wireless routing device is configured with two device identifiers, an SSID in the first device identifier, i.e., a first SSID is a hidden SSID and an SSID in the second device identifier, i.e., a second SSID is an open SSID. Or, the first SSID is an open SSID and the second SSID is an open SSID; or both of the first SSID and the second SSID can be open SSIDs or hidden SSIDs. The first SSID is used by the terminal device to communicate authentication information by sending a connection request; all the connection requests sent to the first SSID will be rejected by the wireless routing device; the second SSID is used by the terminal device to establish a wireless connection.

The terminal device receives a code string from a network device as its authentication information in advance. The terminal device sends a connection request to the first SSID according to a preset rule and sends the code string to the wireless routing device. The preset rule comprises: sending a connection request to the wireless routing device for multiple times according to a connection request sending mechanism indicated by a preset code string, 1 in the code string indicates sending a connection request and 0 indicates waiting for a preset time interval. In an example, the code string is 10111101. The terminal device sends a connection request to the first SSID, waits for a time interval of 20 ms, sends a connection request to the first SSID, sends a connection request to the first SSID, sends a connection request to the first SSID, sends a connection request to the first SSID, waits for a time interval of 20 ms, and sends a connection request to the first SSID.

In one embodiment, the network device may configure different preset code strings for different terminal devices as authentication information, and store corresponding preset code strings in the network device according to the identification information of the terminal devices.

Identical preset code string may be configured for different terminal devices as authentication information and the preset code string is stored in the network device.

The built-in code string of the wireless routing device can be used as authentication information and the built-in code string along with the identification information of the wireless routing device are sent to the terminal device.

The wireless routing device rejects the connection request sent by the terminal device for the first SSID according to a preset rule, and records a connection event until a preset condition is satisfied.

In an example, the preset condition is that a connection request sent by the terminal device for the first SSID is not received when a preset time period is passed, for example, 1s. When the terminal device sends a connection request to the first SSID, waiting for a time interval of 20 ms is represented by 0 in the code string received from the network device in advance, the fact that a connection request sent by the terminal device for the first SSID is not received when is is passed may represent that code string sending is completed. It should be noted that successive 0s may appear in the code string. The length of the code string or the number of successive 0s in the code string may be preset in advance to guarantee that the preset time period in the preset condition is much longer than the time needed by the successive 0s in the code string to prevent false determination.

In one embodiment, if the wireless routing device has rejected the connection request from the terminal device for a preset number of times, it is concluded that the terminal device has completed sending the connection request which carries authentication information. The preset number of times is larger than the number of digits of the code string. In one embodiment, a specific format of a header and a tail, such as 111, may be configured for the code string to distinguish from other code strings.

The connection request contains identification information of the terminal device to identify different terminal devices. The wireless routing device may reject connection requests sent by multiple terminal devices to the first SSID at the same time and record a connection event respectively and independently.

In one implementation of step S12, the wireless routing device parses from the recorded connection events of the terminal device into a code string according to a preset rule as the authentication information of the terminal device.

The preset rule for the wireless routing device to parse the connection events of the terminal device into a code string is identical with the preset rule for the terminal device to send a connection request to the first SSID. In an example, a connection event in which the terminal device sends a connection request to the first SSID, waits for a time interval of 20 ms, sends a connection request to the first SSID, sends a connection request to the first SSID, sends a connection request to the first SSID, sends a connection request to the first SSID, waits for a time interval of 20 ms, and sends a connection request to the first SSID is parsed as a code string “10111101”.

In one implementation of step S13, the wireless routing device obtains identification information of the terminal device and a corresponding code string from the network device in advance, or the wireless routing device uses the identification information of the terminal device to obtain a corresponding code string from other network devices. The wireless routing device determines whether the parsed code string matches with a code string corresponding to the terminal device, and if yes, authentication is passed.

In one embodiment, the wireless routing device obtains a preset code string from the network device in advance. The wireless routing device determines whether the parsed code string matches with the preset code string, and if yes, authentication is passed.

In one embodiment, the wireless routing device determines whether the parsed code string matches with a built-in code string of the wireless routing device, and if yes, authentication is passed.

In an example, identification information of the terminal device may be added to a white list which is stored in the wireless routing device.

In one embodiment, the wireless routing device may return the authentication result to the terminal device. If authentication result indicates that authentication is passed, the terminal device may send a connection request to the second SSID of the wireless routing device. If authentication result indicates that authentication fails, the terminal device may continue to send a connection request to the first SSID of the wireless routing device according to the connection request sending mechanism indicated by the preset code string.

In another implementation of step S13, the wireless routing device sends the parsed code string and identification information of the corresponding terminal device to the network device. The network device determines whether the parsed code string matches with a code string corresponding to the terminal device, and if yes, authentication is passed.

In one embodiment, the wireless routing device sends the parsed code string and identification information of the corresponding terminal device to the network device. The network device determines whether the parsed code string matches with the preset code string, and if yes, authentication is passed.

In one embodiment, the wireless routing device sends the parsed code string and identification information of the corresponding terminal device to the network device. The network device determines whether the parsed code string matches with the built-in code string of the wireless routing device, and if yes, authentication is passed.

The network device sends the authentication result to the wireless routing device. The wireless routing device may add the identification information of the terminal device to a white list which is stored in the wireless routing device.

In one embodiment, the wireless routing device may forward the authentication result to the terminal device. If authentication result indicates that authentication is passed, the terminal device may send a connection request to the second SSID of the wireless routing device. If authentication result indicates that authentication fails, the terminal device may continue to send a connection request to the first SSID of the wireless routing device according to the connection request sending mechanism indicated by the preset code string.

In one implementation of step S14, the wireless routing device receives a connection request sent by the terminal device for the second SSID of the wireless routing device, obtains the identification information of the terminal device carried in the connection request, determines whether the identification information is in the white list, and if yes, permits the terminal device to access the second SSID.

In one embodiment, after communicating authentication information for the first SSID of the wireless routing device, the terminal device sends a connection request for the second SSID of the wireless routing device, until the wireless routing device performs authentication on the terminal device and permits the terminal device to access the second SSID.

In one embodiment, after communicating authentication information for the first SSID of the wireless routing device, the terminal device waits for a preset time period, e.g., 1s, to wait for the wireless routing device to perform authentication on the terminal device and then sends a connection request for the second SSID of the wireless routing device. Burden on the wireless routing device is reduced and power consumption of the terminal device is reduced.

In one embodiment, after obtaining information indicating that authentication is passed which is returned by the wireless routing device, the terminal device sends a connection request for the second SSID of the wireless routing device.

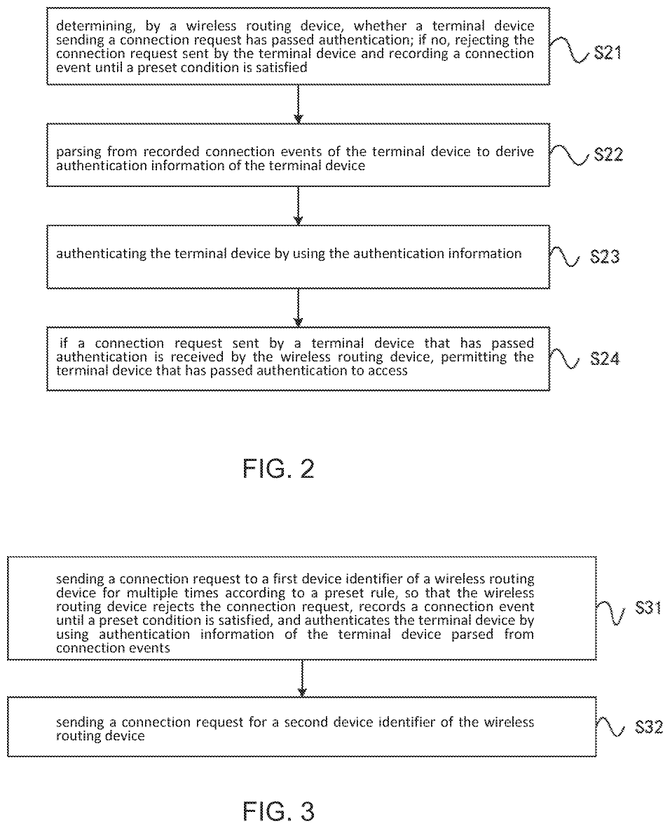

FIG. 2 is a schematic flowchart of a method for wireless access authentication provided by a second embodiment of the present application. As illustrated in FIG. 2, the method comprises the following steps:

step S21, determining, by the wireless routing device, whether the terminal device sending the connection request has passed authentication; if no, rejecting the connection request sent by the terminal device for the wireless routing device and recording a connection event until a preset condition is satisfied;

step S22, parsing from recorded connection events of the terminal device to derive authentication information of the terminal device;

step S23, authenticating the terminal device by using the authentication information;

step S24, if a connection request for the wireless routing device sent by a terminal device that has passed authentication is received by the wireless routing device, permitting the terminal device that has passed authentication to access.

The method of FIG. 2 may be performed by the wireless routing device.

The wireless routing device may be an access point providing wireless network access service, a terminal device hotspot, etc. The wireless network includes, but is not limited to, a wireless local area network based on the IEEE802.11 series of standard protocols, for example, a wireless local area network based on the IEEE802.11n protocol, that is, a commonly-called WiFi network. The terminal device may access a corresponding wireless network through the wireless routing device. In subsequent embodiments of the present disclosure, a wireless routing device accessing a WiFi network will be used as an example for description.

The terminal device includes but is not limited to any type of smart terminal device for implementing wireless communication functions, such as a smart phone, a tablet computer, etc. The smart terminal device can adopt any operating system, such as an Android operating system, an iOS operating system, a Windows operating system, etc.

In one implementation of step S21, the terminal device receives a code string from a network device as its authentication information in advance. The terminal device sends a connection request to the wireless routing device according to a preset rule and sends the code string to the wireless routing device. The preset rule comprises: sending a connection request to the wireless routing device for multiple times according to a connection request sending mechanism indicated by a preset code string, 1 in the code string indicates sending a connection request and 0 indicates waiting for a preset time interval. In an example, the code string is 10111101. The terminal device sends a connection request to the wireless routing device, waits for a time interval of 20 ms, sends a connection request to the wireless routing device, sends a connection request to the wireless routing device, sends a connection request to the wireless routing device, sends a connection request to the wireless routing device, waits for a time interval of 20 ms, and sends a connection request to the wireless routing device.

In one embodiment, the network device may configure different preset code strings for different terminal devices as authentication information, and store corresponding preset code strings in the network device according to the identification information of the terminal devices.

Identical preset code string may be configured for different terminal devices as authentication information and the preset code string is stored in the network device.

The built-in code string of the wireless routing device can be used as authentication information and the built-in code string along with the identification information of the wireless routing device are sent to the terminal device.

The wireless routing device receives the connection request sent by the terminal device, obtains the identification information of the terminal device carried in the connection request, and determines whether the identification information is in a white list. If the identification information is in the white list, the terminal device is identified as passing authentication and is permitted to access; and if the identification information is not in the white list, the terminal device is identified as not passing the authentication. The wireless routing device rejects the connection request sent by the terminal device, and records a connection event until a preset condition is satisfied.

In an example, the preset condition is that a connection request sent by the terminal device is not received when a preset time period is passed, for example, Is. When the terminal device sends a connection request, waiting for a time interval of 20 ms is represented by 0 in the code string received from the network device in advance, the fact that a connection request sent by the terminal device is not received when 1s is passed may represent that code string sending is completed. It should be noted that successive 0s may appear in the code string. The length of the code string or the number of successive 0s in the code string may be preset in advance to guarantee that the preset time period in the preset condition is much longer than the time needed by the successive 0s in the code string to prevent false determination.

In one embodiment, if the wireless routing device has rejected the connection request from the terminal device for a preset number of times, it is concluded that the terminal device has completed sending the connection request which carries authentication information. The preset number of times is larger than the number of digits of the code string. In one embodiment, a specific format of a header and a tail, such as 111, may be configured for the code string to distinguish from other code strings.

The connection request contains identification information of the terminal device to identify different terminal devices. The wireless routing device may reject connection requests sent by multiple terminal devices at the same time and record a connection event respectively and independently.

In one implementation of step S22, the wireless routing device parses from the recorded connection events of the terminal device into a code string according to a preset rule as the authentication information of the terminal device.

The preset rule for the wireless routing device to parse the connection events of the terminal device into a code string is identical with the preset rule for the terminal device to send a connection request. In an example, a connection event in which “sending a connection request, waiting for a time interval of 20 ms, sending a connection request, sending a connection request, sending a connection request, sending a connection request, waiting for a time interval of 20 ms, sending a connection request” is parsed as a code string “10111101”.

In one implementation of step S23, the wireless routing device obtains identification information of the terminal device and a corresponding code string from the network device in advance, or the wireless routing device uses the identification information of the terminal device to obtain a corresponding code string from other network devices. The wireless routing device determines whether the parsed code string matches with a code string corresponding to the terminal device, and if yes, authentication is passed.

In one embodiment, the wireless routing device obtains a preset code string from the network device in advance. The wireless routing device determines whether the parsed code string matches with the preset code string, and if yes, authentication is passed.

In one embodiment, the wireless routing device determines whether the parsed code string matches with a built-in code string of the wireless routing device, and if yes, authentication is passed.

In an example, the wireless routing device may add the identification information of the terminal device to a white list which is stored in the wireless routing device.

In one embodiment, the wireless routing device may return the authentication result to the terminal device. If authentication result indicates that authentication is passed, the terminal device may send a connection request to the wireless routing device. If authentication result indicates that authentication fails, the terminal device may continue to send a connection request to the wireless routing device according to the connection request sending mechanism indicated by the preset code string.

In one implementation of step S23, the wireless routing device sends the parsed code string and identification information of the corresponding terminal device to the network device. The network device determines whether the parsed code string matches with a code string corresponding to the terminal device, and if yes, authentication is passed.

In one embodiment, the wireless routing device sends the parsed code string and identification information of the corresponding terminal device to the network device. The network device determines whether the parsed code string matches with the preset code string, and if yes, authentication is passed.

In one embodiment, the wireless routing device sends the parsed code string and identification information of the corresponding terminal device to the network device. The network device determines whether the parsed code string matches with the built-in code string of the wireless routing device, and if yes, authentication is passed.

The network device sends the authentication result to the wireless routing device. The wireless routing device may add the identification information of the terminal device to a white list which is stored in the wireless routing device.

In one embodiment, the wireless routing device may forward the authentication result to the terminal device. If authentication result indicates that authentication is passed, the terminal device may send a connection request to the wireless routing device. If authentication result indicates that authentication fails, the terminal device may continue to send a connection request to the wireless routing device according to the connection request sending mechanism indicated by the preset code string.

In one implementation of step S24, after communicating authentication information to the wireless routing device, the terminal device waits for a preset time period, e.g., Is, to wait for the wireless routing device to perform authentication on the terminal device and then sends a connection request to the wireless routing device one more time.

In one embodiment, after obtaining information indicating that the authentication is passed which is returned by the wireless routing device, the terminal device sends a connection request to the wireless routing device one more time.

If the wireless routing device receives a connection request sent by a terminal device that has passed authentication, since the identification information of the terminal device has been added to the white list, which means the terminal device is identified as passing the authentication, the wireless routing device permits the terminal device that has passed authentication to access.

FIG. 3 is a schematic flowchart of a method for wireless access authentication provided by a third embodiment of the present application. As illustrated in FIG. 3, the method comprises the following steps:

step S31, sending a connection request to a first device identifier of the wireless routing device for multiple times according to a preset rule, so that the wireless routing device rejects the connection request, records a connection event until a preset condition is satisfied, and authenticates the terminal device by using authentication information of the terminal device parsed from the connection event;

step S32, sending a connection request for a second device identifier of the wireless routing device.

The method of FIG. 3 may be performed by the terminal device.

The terminal device includes but is not limited to any type of smart terminal device for implementing wireless communication functions, such as a smart phone, a tablet computer, etc. The smart terminal device can adopt any operating system, such as an Android operating system, an iOS operating system, a Windows operating system, etc.

The wireless routing device may be an access point providing wireless network access service, a terminal device hotspot, etc. The wireless network includes, but is not limited to, a wireless local area network based on the IEEE802.11 series of standard protocols, for example, a wireless local area network based on the IEEE802.11n protocol, that is, a commonly-called WiFi network. The terminal device may access a corresponding wireless network through the wireless routing device. In subsequent embodiments of the present disclosure, a wireless routing device accessing a WiFi network will be used as an example for description.

In one implementation of step S31, the wireless routing device is configured with a plurality of device identifiers. The device identifier is an SSID (service set identifier) of a wireless access point. The SSID is used to identify a wireless network corresponding to the wireless routing device. Further, the SSID may be further refined into BSSID (Basic Service Set Identifier) and ESSID (Extended Service Set Identifier, Service Differentiation Number), the BSSID is used to identify a relatively small BSS (Basic Service Set, base station system) area, each host communicates in this relatively small area, while the ESSID is applied to a more complex wireless network with a larger scale.

Here, different BSSs can be extended to corresponding ESSs (Extended Service Set, multiple base station systems). In subsequent embodiments of the present disclosure, the MAC (Media Access Control) of a wireless access point is used as the BSSID of the wireless access point. In one embodiment, the device identifier is the SSID and BSSID of the wireless access point.

In one embodiment, the wireless routing device is configured with two device identifiers, an SSID in the first device identifier, i.e., a first SSID is a hidden SSID and an SSID in the second device identifier, i.e., a second SSID is an open SSID. Or, the first SSID is an open SSID and the second SSID is an open SSID; or both of the first SSID and the second SSID can be open SSIDs or hidden SSIDs.

The first SSID is used by the terminal device to communicate authentication information by sending a connection request; all the connection requests sent to the first SSID will be rejected by the wireless routing device; the second SSID is used by the terminal device to establish a wireless connection.

The terminal device receives a code string from a network device as its authentication information in advance. The terminal device sends a connection request to the first SSID according to a preset rule and sends the code string to the wireless routing device. The preset rule comprises: sending a connection request to the wireless routing device for multiple times according to a connection request sending mechanism indicated by a preset code string, 1 in the code string indicates sending a connection request and 0 indicates waiting for a preset time interval. In an example, the code string is 10111101. The terminal device sends a connection request to the first SSID, waits for a time interval of 20 ms, sends a connection request to the first SSID, sends a connection request to the first SSID, sends a connection request to the first SSID, sends a connection request to the first SSID, waits for a time interval of 20 ms, and sends a connection request to the first SSID.

In one embodiment, the network device may configure different preset code strings for different terminal devices as authentication information, and store corresponding preset code strings in the network device according to the identification information of the terminal devices.

Identical preset code string may be configured for different terminal devices as authentication information and the preset code string is stored in the network device.

The built-in code string of the wireless routing device can be used as authentication information and the built-in code string along with the identification information of the wireless routing device are sent to the terminal device.

The wireless routing device rejects the connection request sent by the terminal device for the first SSID according to a preset rule, and records a connection event until a preset condition is satisfied.

In an example, the preset condition is that a connection request sent by the terminal device for the first SSID is not received when a preset time period is passed, for example, 1s. When the terminal device sends a connection request to the first SSID, waiting for a time interval of 20 ms is represented by 0 in the code string received from the network device in advance, the fact that a connection request sent by the terminal device for the first SSID is not received when 1s is passed may represent that code string sending is completed. It should be noted that successive 0s may appear in the code string. The length of the code string or the number of successive 0s in the code string may be preset in advance to guarantee that the preset time period in the preset condition is much longer than the time needed by the successive 0s in the code string to prevent false determination.

In an example, the preset rule is that if the wireless routing device has rejected the connection request from the terminal device for a preset number of times, it is concluded that the terminal device has completed sending connection request which carries authentication information. The preset number of times is larger than the number of digits of the code string. In one embodiment, a specific format of a header and a tail, such as 111, may be configured for the code string to distinguish from other code strings.

The connection request contains identification information of the terminal device to identify different terminal devices. A plurality of terminal devices may send a connection request to the first SSID of the wireless routing device at the same time. The wireless routing device may reject the connection requests sent by the plurality of terminal devices to the first SSID at the same time and record a connection event respectively and independently.

The wireless routing device parses from the recorded connection events of the terminal device into a code string according to a preset rule as the authentication information of the terminal device. The preset rule for the wireless routing device to parse the connection events of the terminal device into a code string is identical with the preset rule for the terminal device to send a connection request to the first SSID. In an example, a connection event in which “sending a connection request, waiting for a time interval of 20 ms, sending a connection request, sending a connection request, sending a connection request, sending a connection request, waiting for a time interval of 20 ms, sending a connection request” is parsed as a code string “10111101”.

In one embodiment, the wireless routing device determines whether the parsed code string matches with a preset code string, and if yes, authentication is passed, otherwise authentication fails.

In one embodiment, the wireless routing device sends the parsed code string to the network device. The network device determines whether the parsed code string matches with a preset code string, and if yes, authentication is passed, otherwise authentication fails. The network device sends the authentication result to the wireless routing device.

The wireless routing device may add the identification information of the terminal device to a white list which is stored in the wireless routing device.

In one embodiment, the wireless routing device may return the authentication result to the terminal device. If authentication result indicates that authentication is passed, the terminal device may send a connection request for the second SSID of the wireless routing device. If authentication result indicates that authentication fails, the terminal device may continue to send a connection request for the first SSID of the wireless routing device according to the connection request sending mechanism indicated by the preset code string.

The terminal device receives the authentication result returned by the wireless routing device.

In one implementation of step S32, after communicating authentication information for the first SSID of the wireless routing device, the terminal device waits for a preset time period, e.g., 1s, to wait for the wireless routing device to perform authentication on the terminal device and then sends a connection request for the second SSID of the wireless routing device. Burden on the wireless routing device is reduced and power consumption of the terminal device is reduced.

In one embodiment, since the first SSID and the second SSID of the wireless routing device are independent from each other, after communicating authentication information for the first SSID of the wireless routing device, the terminal device may not need to wait for a preset time period and send a connection request for the second SSID of the wireless routing device until the wireless routing device performs authentication on the terminal device and permits the terminal device to access the second SSID.

In one embodiment, after obtaining information indicating that authentication is passed which is returned by the wireless routing device, the terminal device sends a connection request for the second SSID of the wireless routing device.

Since the identification information of the terminal device has been added to the white list, the wireless routing device permits the terminal device to access. The wireless routing device permits the terminal device to access the second SSID.

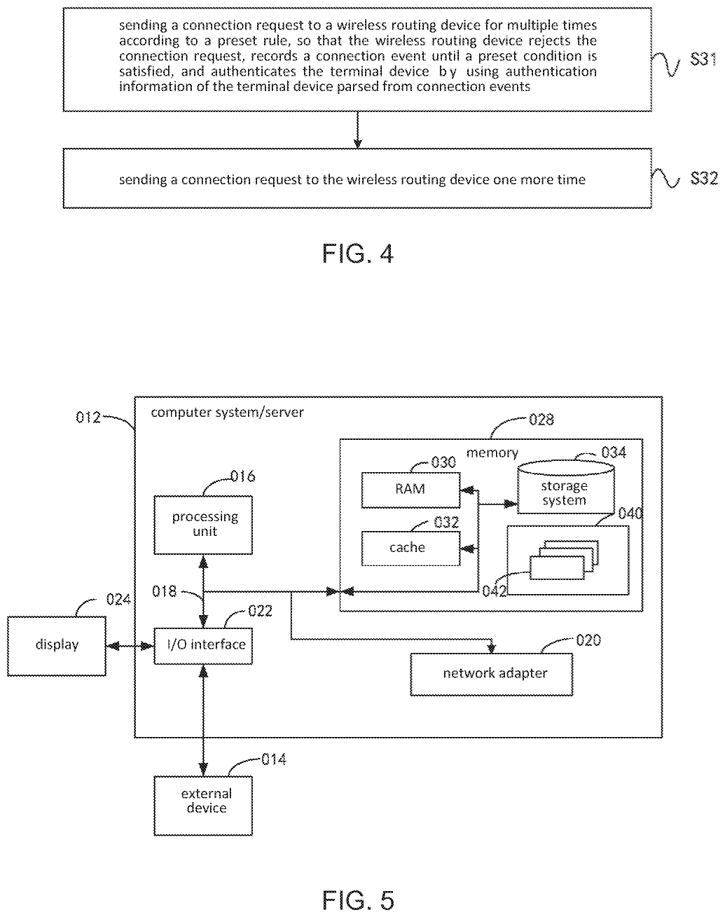

FIG. 4 is a schematic flowchart of a method for wireless access authentication provided by a fourth embodiment of the present application. As illustrated in FIG. 4, the method comprises the following steps:

step S41, sending a connection request to a wireless routing device for multiple times according to a preset rule, so that the wireless routing device rejects the connection request, records a connection event until a preset condition is satisfied, and authenticates the terminal device by using authentication information of the terminal device parsed from the connection event;

step S42, sending a connection request to the wireless routing device one more time.

The method of FIG. 4 may be performed by the terminal device.

The terminal device includes but is not limited to any type of smart terminal device for implementing wireless communication functions, such as a smart phone, a tablet computer, etc. The smart terminal device can adopt any operating system, such as an Android operating system, an iOS operating system, a Windows operating system, etc.

The wireless routing device may be an access point providing wireless network access service, a terminal device hotspot, etc. The wireless network includes, but is not limited to, a wireless local area network based on the IEEE802.11 series of standard protocols, for example, a wireless local area network based on the IEEE802.11n protocol, that is, a commonly-called WiFi network. The terminal device may access a corresponding wireless network through the wireless routing device. In subsequent embodiments of the present disclosure, a wireless routing device accessing a WiFi network will be used as an example for description.

In one implementation of step S41, the terminal device receives a code string from a network device as its authentication information in advance. The terminal device sends a connection request to the wireless routing device according to a preset rule and sends the code string to the wireless routing device. The preset rule comprises: sending a connection request to the wireless routing device for multiple times according to a connection request sending mechanism indicated by a preset code string, 1 in the code string indicates sending a connection request and 0 indicates waiting for a preset time interval. In an example, the code string is 10111101. The terminal device sends a connection request to the wireless routing device, waits for a time interval of 20 ms, sends a connection request to the wireless routing device, sends a connection request to the wireless routing device, sends a connection request to the wireless routing device, sends a connection request to the wireless routing device, waits for a time interval of 20 ms, and sends a connection request to the wireless routing device.

In one embodiment, the network device may configure different preset code strings for different terminal devices as authentication information, and store corresponding preset code strings in the network device according to the identification information of the terminal devices.

Identical preset code string may be configured for different terminal devices as authentication information and the preset code string is stored in the network device.

The built-in code string of the wireless routing device can be used as authentication information and the built-in code string along with the identification information of the wireless routing device are sent to the terminal device.

In one embodiment, the wireless routing device receives a connection request sent by the terminal device, obtains identification information of the terminal device carried in the connection request, and determines whether the identification information is in the white list. If the identification information is in the white list, the terminal device is identified as passing the authentication and is permitted to access. If the identification information is not in the white list, the wireless routing device rejects the connection request sent by the terminal device and records a connection event until a preset condition is satisfied.

In an example, the preset condition is that a connection request sent by the terminal device is not received when a preset time period is passed, for example, Is. When the terminal device sends a connection request, waiting for a time interval of 20 ms is represented by 0 in the code string received from the network device in advance, the fact that a connection request sent by the terminal device is not received when 1s is passed may represent that code string sending is completed.

It should be noted that successive 0s may appear in the code string. The length of the code string or the number of successive 0s in the code string may be preset in advance to guarantee that the preset time period in the preset condition is much longer than the time needed by the successive 0s in the code string to prevent false determination.

In an example, the preset rule is that if the wireless routing device has rejected the connection request from the terminal device for a preset number of times, it is concluded that the terminal device has completed sending the connection request which carries authentication information. The preset number of times is larger than the number of digits of the code string. In one embodiment, a specific format of a header and a tail, such as 111, may be configured for the code string to distinguish from other code strings.

The connection request contains identification information of the terminal device to identify different terminal devices. A plurality of terminal devices may send a connection request to the wireless routing device at the same time. The wireless routing device may reject the connection requests sent by the plurality of terminal devices at the same time and record a connection event respectively and independently.

In one embodiment, the wireless routing device parses from the recorded connection events of the terminal device into a code string according to a preset rule as the authentication information of the terminal device. The preset rule for the wireless routing device to parse the connection events of the terminal device into a code string is identical with the preset rule for the terminal device to send a connection request. In an example, a connection event in which “sending a connection request, waiting for a time interval of 20 ms, sending a connection request, sending a connection request, sending a connection request, sending a connection request, waiting for a time interval of 20 ms, sending a connection request” is parsed as a code string “10111101”.

In one embodiment, the wireless routing device determines whether the parsed code string matches with a preset code string, and if yes, authentication is passed, otherwise authentication fails.

In one embodiment, the wireless routing device sends the parsed code string to the network device. The network device determines whether the parsed code string matches with a preset code string, and if yes, authentication is passed, otherwise authentication fails. The network device sends the authentication result to the wireless routing device.

The wireless routing device may add the identification information of the terminal device to a white list which is stored in the wireless routing device.

In one embodiment, the wireless routing device may return the authentication result to the terminal device. If authentication result indicates that authentication is passed, the terminal device may send a connection request to the wireless routing device. If authentication result indicates that authentication fails, the terminal device may continue to send a connection request to the wireless routing device according to the connection request sending mechanism indicated by the preset code string.

In one implementation of step S42, after communicating authentication information to the wireless routing device, the terminal device waits for a preset time period, e.g., Is, to wait for the wireless routing device to perform authentication on the terminal device and then sends a connection request to the wireless routing device. Impacts on parsing the connection events by the wireless routing device are avoided.

In one embodiment, after obtaining information indicating that authentication is passed which is returned by the wireless routing device, the terminal device sends a connection request for the wireless routing device.

Since the identification information of the terminal device has been added to the white list, the wireless routing device permits the terminal device to access.

In the embodiments of the present disclosure, when the terminal device is prepared to access the wireless routing device, the terminal device does not need to establish a connection with the network device for access information to input the access information to the wireless routing device. The terminal device can send authentication information to the wireless routing device without connection and access the wireless routing device after authentication is passed by simply obtaining the authentication information allocated by the network device for the terminal device in advance. The flexibility of use of wireless access is improved.

FIG. 5 shows a block diagram of an exemplary computer system/server 012 suitable for implementing the embodiments of the present disclosure. The computer system/server 012 shown in FIG. 5 is merely an example, and should not impose any limitation on the functions and scope of use of the embodiments of the present application.

As shown in FIG. 5, the computer system/server 012 is embodied as a general-purpose computing device. Components of the computer system/server 012 may include but are not limited to one or more processors or processing units 016, a system memory 028, a bus 018 connecting different system components (including the system memory 028 and the processing unit 016).

The bus 018 represents one or more of several types of bus structures, including a memory bus or a memory controller, a peripheral bus, a graphics acceleration port, a processor, or a local area bus using any of a variety of bus structures. By way of example, these architectures include, but are not limited to, an Industry Standard Architecture (ISA) bus, a Micro Channel Architecture (MAC) bus, an enhanced ISA bus, a Video Electronics Standards Association (VESA) local area bus, and a peripheral component interconnect (PCI) bus.

Computer system/server 012 typically includes a variety of computer system readable media. These media can be any available media that can be accessed by the computer system/server 012, including volatile and non-volatile media, removable and non-removable media.

The system memory 028 may include computer system readable media in the form of a volatile memory, such as a random access memory (RAM) 030 and/or a cache memory 032. Computer system/server 012 may further include other removable/non-removable, volatile/nonvolatile computer system storage media. By way of example only, the storage system 034 may be used to read and write non-removable, non-volatile magnetic media (not shown in FIG. 5 and is commonly referred to as a “hard drive”). Although not shown in FIG. 5, a magnetic disk drive for reading and writing to a removable non-volatile magnetic disk (for example, “a floppy disk”) and an optical disk drive for reading and writing to a removable non-volatile optical disk (for example, CD-ROM, DVD-ROM or other optical media) may be provided. In these cases, each drive may be connected to the bus 018 through one or more data media interfaces. The memory 028 may include at least one program product having a set of (e.g., at least one) program modules configured to perform the functions of the embodiments of the present disclosure.

A program/utility tool 040 having a set of (at least one) program modules 042 may be stored in, for example, the memory 028. Such program modules 042 include, but are not limited to, an operating system, one or more application programs, other programs modules and program data, each or some combination of these examples may include implementations of the network environment. The program module 042 generally performs functions and/or methods in the embodiments described in the present disclosure.

The computer system/server 012 can also communicate with one or more external devices 014 (e.g., a keyboard, a pointing device, a display 024, etc.). In the present disclosure, the computer system/server 012 can communicate with external radar devices, and can also communicate with one or more devices that enable users to interact with the computer system/server 012, and/or with any device (such as a network card, a modem, etc.) that enables the computer system/server 012 to communicate with one or more other computing devices. Such communication can be performed through an input/output (I/O) interface 022. Moreover, the computer system/server 012 can also communicate with one or more networks (such as a local area network (LAN), a wide area network (WAN), and/or a public network, such as the Internet) through a network adapter 020. As shown in FIG. 5, the network adapter 020 communicates with other modules of the computer system/server 012 through the bus 018. It should be understood that although not shown in the figure, other hardware and/or software modules may be used in conjunction with the computer system/server 012, including but not limited to: microcode, device drivers, redundant processing units, external disk drive arrays, RAID systems, tape drives and data backup storage systems.

The processing unit 016 executes programs stored in the system memory 028 to execute the functions and/or methods in the embodiments described in the present application.

The above-mentioned computer program may be set in a computer storage medium, that is, the computer storage medium is encoded with a computer program, which when executed by one or more computers, causes the one or more computers to execute the method flow and/or apparatus operations shown in the above-described embodiments of the present disclosure.

With the development of time and technology, the meaning of media has become more and more extensive. The propagation method of computer programs is no longer limited to tangible media. Computer programs can also be downloaded directly from the network. Any combination of one or more computer-readable media may be used. The computer-readable medium may be a computer-readable signal medium or a computer-readable storage medium. The computer-readable storage medium may be, for example, but not limited to, an electronic, magnetic, optical, electromagnetic, infrared, or semiconductor system, apparatus, or device, or any combination thereof. More specific examples (non-exhaustive list) of computer-readable storage media may include: electrical connections with one or more wires, portable computer magnetic disks, hard disks, a random access memory (RAM), a read-only memory (ROM), an erasable programming read-only memory (EPROM or flash memory), an optical fiber, a portable compact disk read-only memory (CD-ROM), an optical storage device, a magnetic storage device, or any suitable combination of the foregoing. In the present document, a computer-readable storage medium may be any tangible medium that contains or stores a program that can be used by or in combination with an instruction execution system, apparatus, or device.

A computer-readable signal medium may include a data signal that is included in a baseband or propagated as part of a carrier wave, and which carries computer-readable program code. Such a propagated data signal may take many forms, including but not limited to electromagnetic signals, optical signals, or any suitable combination of the foregoing. The computer-readable signal medium may also be any computer-readable medium other than a computer-readable storage medium, and the computer-readable medium may send, propagate, or transmit a program for use by or in connection with an instruction execution system, apparatus, or device.

Program code embodied on a computer-readable medium may be transmitted using any appropriate medium, including but not limited to: wireless, wired, optical fiber cable, RF, etc., or any suitable combination of the foregoing.

Computer program code for performing the operations of the present disclosure may be written in one or more programming languages, or a combination thereof, including object oriented programming languages such as Java, Smalltalk, C++, and conventional procedural programming language, such as “C” or similar programming language. The program code can be executed entirely on the user's computer, partly on the user's computer, as an independent software package, partly on the user's computer and partly on a remote computer, or entirely on a remote computer or server. In the case of a remote computer, the remote computer can be connected to the user's computer through any kind of network, including a local area network (LAN) or wide area network (WAN), or it can be connected to an external computer (for example through Internet connection provided by an Internet service provider).

Finally, it should be noted that the above embodiments are merely used to illustrate embodiments of the present application, not to limit them; although the present application has been described in detail with reference to the foregoing embodiments, and these modifications or replacements do not deviate from the spirit and scope of the embodiments of the present application.

What is claimed is:

1. A method for wireless access authentication, comprising:
rejecting, by a wireless routing device, a connection request sent by a terminal device and recording a connection event until a preset condition is satisfied;
parsing from one or more recorded connection events of the terminal device to derive authentication information of the terminal device; and
authenticating the terminal device by using the authentication information.

2. The method as recited in claim 1, wherein the connection request is sent for a first device identifier of the wireless routing device.

3. The method as recited in claim 2, wherein the method further comprising:
if a connection request for a second device identifier of the wireless routing device sent by a terminal device that has passed authentication is received, permitting the terminal device that has passed authentication to access the second device identifier.

4. The method as recited in claim 1, wherein the step of rejecting, by the wireless routing device, the connection request sent by the terminal device and recording a connection event until a preset condition is satisfied, comprising:
determining, by the wireless routing device, whether the terminal device sending the connection request has passed authentication;
if no, rejecting the connection request sent by the terminal device and recording a connection event until a preset condition is satisfied.

5. The method as recited in claim 1, wherein the preset condition comprising:
a connection request sent by the terminal device is not received when a preset time period is passed; or
the connection request sent by the terminal device has been rejected for a preset number of times.

6. The method as recited in claim 2, wherein an SSID in the first device identifier is a hidden SSID and an SSID in a second device identifier is an open SSID; or an SSID in the first device identifier is an open SSID and an SSID in the second device identifier is an open SSID.

7. The method as recited in claim 1, wherein the step of parsing from one or more recorded connection events of the terminal device to derive the authentication information comprising:
parsing the one or more recorded connection events of the terminal device into a code string according to a preset rule.

8. The method as recited in claim 7, wherein the preset rule comprising:
receiving a connection request is represented by a binary code 1 and waiting for a preset time interval is represented by a binary code 0.

9. The method as recited in claim 7, wherein the step of authenticating the terminal device by using the authentication information comprising:
determining whether a parsed code string matches with a preset code string; and if yes, authentication is passed, otherwise authentication fails.

10. The method as recited in claim 9, wherein the preset code string comprising:
a preset code string obtained from a network device by the wireless routing device or a built-in code string of the wireless routing device.

11. The method as recited in claim 1, wherein the method further comprising:
returning the authentication result to the terminal device.

12. A method for wireless access authentication, comprising:
sending a connection request to a wireless routing device for multiple times according to a preset rule, so that the wireless routing device rejects the connection request, records a connection event until a preset condition is satisfied, and authenticating a terminal device by using authentication information of the terminal device parsed from connection events; and
sending an additional connection request to the wireless routing device.

13. The method according to claim 12, wherein
the step of sending a connection request to the wireless routing device for multiple times according to a preset rule comprising: sending a connection request for a first device identifier of the wireless routing device for multiple times according to the preset rule.

14. The method as recited in claim 13, wherein the step of sending a connection request to the wireless routing device one more time comprising:
sending a connection request for a second device identifier of the wireless routing device.

15. The method as recited in claim 14, wherein an SSID in the first device identifier is a hidden SSID and an SSID in the second device identifier is an open SSID; or an SSID in the first device identifier is an open SSID and an SSID in the second device identifier is an open SSID.

16. The method as recited in claim 12, wherein the step of sending an additional connection request to the wireless routing device comprising:
sending an additional connection request to the wireless routing device when a preset time period is passed after completing sending of a connection request to the wireless routing device for multiple times; or
sending an additional connection request to the wireless routing device after information indicating that authentication is passed is returned by the wireless routing device is obtained.

17. The method as recited in claim 12, wherein the preset rule comprising:
sending a connection request to the wireless routing device for multiple times according to a connection request sending mechanism indicated by a preset code string, wherein 1 in the preset code string indicates sending a connection request and 0 indicates waiting for a preset time interval.

18. The method as recited in claim 17, wherein the preset code string comprising:
a preset code string set for the terminal device by a network device, or a built-in code string of the wireless routing device sent by the network device to the terminal device.

19. A device, comprising:
one or more processors;
a storage device for storing one or more programs,
the one or more programs, when executed by the one or more processors, causing the one or more processors to implement the method as recited in claim 1.
